(19) United States
(12) Patent Application Publication
(10) Pub. No.: US 2025/0236251 A1
(43) Pub. Date: Jul. 24, 2025

(54) CROSSMEMBER

(71) Applicant: ACPS Automotive GmbH, Ingersheim (DE)

(72) Inventor: Ralf Pietschmann, Loechgau (DE)

(73) Assignee: ACPS Automotive GmbH, Ingersheim (DE)

(21) Appl. No.: 19/020,552

(22) Filed: Jan. 14, 2025

(30) Foreign Application Priority Data
Jan. 18, 2024 (DE) 102024101410.5

(51) Int. Cl. B60R 19/18; B60R 19/48

(52) U.S. Cl. CPC B60R 19/18; B60R 19/48; B60R 2019/1806

(57) ABSTRACT

In order to improve an impact-absorbing crossmember which is mountable under a bumper unit of a vehicle body on a vehicle rear thereof, wherein the crossmember extends in a transverse direction running approximately parallel to the bumper unit and has support elements arranged at the ends for support on support regions of the vehicle rear, and wherein the support elements are connected to one another by a central unit of the crossmember, in such a way that the crossmember can be produced as simply as possible and thus as cost-effectively as possible, it is proposed that the central unit has a box-shaped structure comprising wall elements and that at least one of the wall elements of the box-shaped structure has extensions which extend in one piece from the box-shaped structure into the support elements and form a structural element of the support elements.

The present disclosure relates to the subject matter disclosed in German application number 10 2024 101 410.5 of 18 Jan. 2024, which is incorporated herein by reference in its entirety and for all purposes.

### BACKGROUND OF THE INVENTION

The invention relates to an impact-absorbing crossmember that is mountable under a bumper unit of a vehicle body on a vehicle rear thereof, wherein the crossmember extends in a transverse direction running approximately parallel to the bumper unit and has support elements arranged at the ends for support on support regions of the vehicle rear, and wherein the support elements are connected to one another by a central unit of the crossmember.

Crossmembers of this kind are known from the prior art.

In these, the support elements are formed as separate elements that are connected to the central unit using a wide variety of connection techniques.

Such constructions are complex and therefore cost-intensive.

The invention therefore addresses the problem of improving a crossmember of the type described at the outset in such a way that it can be produced as simply and therefore as cost-effectively as possible.

### SUMMARY OF THE INVENTION

In a crossmember of the type described at the outset, this problem is solved in accordance with the invention in that the central unit has a box-shaped structure comprising wall elements and in that at least one of the wall elements of the box-shaped structure has extensions which extend in one piece from this structure into the support elements and form a structural element of the support elements.

The solution according to the invention thus makes it possible to create a simple connection between the central unit and the support elements without the need for connection procedures for this.

In the following description, an approximately parallel course is understood to mean a course that can deviate from a parallel course by an angle of up to ±30°, preferably up to ±20°.

It is particularly favorable if at least two mutually opposite wall elements of the box-shaped structure extend with their extensions in one piece into the support elements and form at least parts of the structure of the support elements.

It is even more advantageous if at least three wall elements of the box-shaped structure extend with their extensions in one piece into the support elements and form at least parts of the structure of the support elements.

A particularly favorable solution is that all wall elements of the box-shaped structure extend with their extensions in one piece into the support elements and form at least a part of the structure, in particular the structure, of the support elements.

This provides a simple way of creating the crossmember in an optimum and cost-effective way, while creating a stable connection between the support elements and the central unit that is easy to implement.

In particular, an advantageous constructional solution provides that one of the wall elements extending in one piece into the support elements forms with its extensions in each of the support elements at least one support surface of the crossmember, which support surface can be placed against one of the support regions of the vehicle rear.

This solution has the great advantage that in particular the support of the crossmember is connected in one piece to the one wall element of the central unit.

It is particularly favorable if the wall element is the vehicle-facing wall element of the box structure.

It has also proved advantageous for the formation of the crossmember that the support surfaces of the crossmember are arranged offset in relation to the central unit in the direction of the vehicle rear, so that when the support surfaces of the crossmember abut against the vehicle rear in the support regions, the parts of the at least one wall element forming these are arranged offset relative to its other parts, in particular to the part of this at least one wall element forming the central unit, in the direction of the vehicle rear and thus the vehicle rear is acted on by the crossmember through the support surfaces only in the region of the support regions of the vehicle rear.

This can also be achieved by arranging the central unit relative to the support surfaces of the support elements such that it runs, in particular with its vehicle-facing wall element, at a spacing from the vehicle rear when the support surfaces abut against the support regions.

These solutions therefore create the possibility that even in the event of at least a minor crash impact on the crossmember, the vehicle rear is primarily acted on at the support regions and not by the central unit itself.

It is also advantageous if the wall element with its extensions forms support plates having support surfaces.

This means that the wall element itself is able to form the support plates that transmit the force to the support regions.

In order to make the support plates as stable as possible, it has proven to be advantageous if the extensions form bends that adjoin the support plates and stiffen them, so that the support plates themselves can be made of the thinnest possible material, in particular sheet material, but have sufficient rigidity due to the bends.

In a simple, advantageous exemplary embodiment, it is provided that the support plates are connected to the wall element in the region of the box structure by inner bends formed by the extensions.

These bends alone contribute significantly to the stiffening of the support plates.

It is even better if the support plates are connected to outer bends on their sides opposite the inner bends, so that the support plates are stiffened by bends on opposite sides.

A further advantageous stiffening of the support plates is achievable if the support plates have at least one bend extending approximately parallel to the transverse direction, preferably two bends arranged on opposite sides and extending approximately parallel to the transverse direction.

These bends, which thus extend transversely to the inner bends and outer bends, serve to stiffen the support plates on all sides.

It has proven to be particularly advantageous if all the bends that stiffen the support plates are integrally molded in one piece onto the support plates.

To avoid stress fractures in the region of the bends, openings are preferably provided in the region thereof and give the bends a limited elasticity of movement so that varying forces can be transferred to the support plates without any problems.

In addition, a further advantageous exemplary embodiment provides that one of the wall elements of the box-shaped structure forms an impact-absorbing impact element thereof facing away from the roadway, which forms impact surfaces both in the region of the central unit and in the region of the support elements and transmits impact forces to the further wall elements of the box-shaped structure and to the support elements.

It is conceivable here, for example, that the impact-absorbing wall element itself has a low deformability.

However, it is also particularly advantageous if the impact-absorbing wall element is itself already deformable and is therefore able to absorb forces through deformation in the event of an impact.

It is particularly favorable here if the impact-absorbing wall element is the wall element of the box-shaped structure facing away from the vehicle.

Furthermore, it has proven to be advantageous if the impact-absorbing impact element is connected to at least one wall element supporting it approximately parallel to the direction of travel, and can therefore also transmit impact forces to this wall element.

Furthermore, it has proven to be advantageous if the at least one wall element supporting the vehicle approximately parallel to the direction of travel is connected to the vehicle-facing wall element.

A particularly favorable solution is for the box-shaped structure to have two wall elements which act in a supporting manner approximately parallel to the direction of travel and are arranged at a spacing from one another.

Furthermore, another advantageous solution is that the at least one wall element acting in a supporting manner in the direction of travel is a roadway-facing wall element of the crossmember.

Another advantageous solution is that the at least one wall element acting in a supporting manner in the direction of travel is a wall element of the crossmember facing away from the roadway.

Furthermore, it is advantageously provided that the at least one wall element acting in a supporting manner in the direction of travel is supported both in the region of the central unit and in the region of the support plates.

Another particularly favorable solution is that the at least one wall element, acting in a supporting manner approximately parallel to the direction of travel is deformable for absorbing impact energy.

Furthermore, it is advantageously provided that at least one wall element, which acts in a supporting manner approximately parallel to the direction of travel, is supported by its one-piece extensions on the support plates in the region of the support elements.

The extensions of this at least one wall element can, for example, be supported by their side edges on the support plates.

However, a particularly favorable solution is that the at least one wall element, which acts in a supporting manner approximately parallel to the direction of travel, is supported by its one-piece extensions by means of support flanges on the support plates.

The support flanges are preferably likewise integrally molded in one piece onto the one-piece extensions and, in particular, abut in a planar manner on the support plates on their sides opposite the support surfaces.

It is particularly advantageous here if the support flanges are connectable to the support regions of the vehicle rear together with the support plates by means of mounting elements acting on both.

This means that, on the one hand, the support flanges serve to support the extensions of the at least one wall element acting in a supporting manner approximately parallel to the direction of travel, but at the same time also serve to stabilize and/or stiffen the support plates, since the mounting elements hold the support flanges and the support plates in contact with one another in a force-loaded manner.

A further advantageous embodiment of the crossmember according to the invention provides that the one-piece extensions of the at least one wall element acting in a supporting manner approximately parallel to the direction of travel form a hollow body which stiffens said wall element.

In this case, the hollow body can usefully not only serve to stiffen the extensions of this at least one wall element, but at the same time can also be formed as a support body and be supported on one of the support plates.

In particular, it is provided here that each hollow body extends in the direction of the corresponding support plate with an increasingly widening cross-section in order to enable this support body to be supported on the corresponding support plate with as little tilting as possible.

A useful constructional solution is for the hollow body to be formed as a semi-pyramid.

It is particularly easy to provide the hollow body in the corresponding extension by forming the hollow body by bending the corresponding extension at least three times.

Furthermore, it is also advantageous for stable support of the hollow body if the respective hollow body is supported by flange elements on the corresponding support plate.

In particular, it is also advantageous for stiffening the respective support plate if the flange elements are connectable to the support regions of the vehicle rear together with the corresponding support plate by means of mounting elements acting on both.

A further advantageous exemplary embodiment provides that the box-shaped structure has at least one wall element which is provided with at least one cut-out.

Such cut-outs open up the possibility of achieving a further weight saving.

It is particularly favorable if the at least one cut-out has an areal extent which corresponds in each direction to a maximum of twice the areal extent of a surface region surrounding it in the corresponding direction, so that each cut-out is still surrounded by a sufficiently stabilizing surface region so as not to significantly reduce the rigidity of the wall element.

In particular, it is provided that the at least one cut-out is surrounded on all sides by the corresponding surface region.

Furthermore, it is preferable that the at least one cut-out has an outer contour with a substantially round and/or oval basic shape, so that no load peaks can occur in the region of the outer contour of the cut-out when the corresponding wall element is loaded.

In addition, in a further advantageous exemplary embodiment, it is preferably provided that the cut-out, with respect to the surface region surrounding it, has a wall region which is raised relative to said surface region.

Such a raised edge region creates the possibility of additionally stabilizing the surface region due to its extent transverse to the surface region surrounding the cut-out.

In particular, it is provided that the raised wall region has a height transverse to the surface region surrounding it which corresponds to at least twice a material thickness of the surface region surrounding it.

In order to optimize the rigidity of the box-shaped structure, it is preferable for at least some of the wall elements of the box-shaped structure, as a result of re-shaping, to have increased rigidity against deformation.

Re-shaping of this kind can be formed in a wide variety of ways.

One possibility is that at least one of the wall elements of the box-shaped structure has a bending line running parallel to a vertical longitudinal center plane.

Another advantageous solution is that at least one of the wall elements has at least one embossed bead.

Preferably, the at least one embossed bead runs in a transverse direction to the vertical longitudinal center plane.

A particularly advantageous form of the crossmember according to the invention is that the central unit is formed in such a way that a hitch element for a trailer or a load carrier is mountable on it, and in that the forces transmitted by the hitch element to the central unit are transmitted from the central unit to the support elements and from these to the support regions of the vehicle rear.

In particular, it is provided here that the box-shaped structure of the central unit carries a mounting unit for the hitch element.

The mounting unit for the hitch element is preferably arranged in the central unit and thus protected by it.

In particular, it is provided here that the mounting unit for the hitch element is arranged in an interior of the central unit.

Such an arrangement of the mounting unit in the interior of the central unit can be realized, for example, by a roadway-facing wall of the central unit having an opening through which the hitch element with the mounting unit is insertable into the interior of the central unit.

It is particularly favorable if the hitch element in its working position reaches through the opening.

The hitch element can, for example, be a removable hitch element that is detachable with the mounting unit and from the mounting unit.

Another advantageous solution is that the hitch element is pivotable relative to the mounting unit between a working position and a rest position.

In this case, it is preferably also provided that the hitch element in its working position reaches through the opening and that the hitch element in a rest position is arranged substantially in the interior of the box-shaped structure of the central unit.

The above description of solutions according to the invention thus comprises, in particular, the various combinations of features defined by the following consecutively numbered embodiments:

An impact-absorbing crossmember (20) which is mountable under a bumper unit (16) of a vehicle body (12) on a vehicle rear (14) thereof, wherein the crossmember (20) extends in a transverse direction (58) running approximately parallel to the bumper unit (16) and has support elements (54, 56) arranged at the ends for support on support regions (64, 66) of the vehicle rear (14), and wherein the support elements (54, 56) are connected to one another by a central unit (52) of the crossmember (20), wherein the central unit (52) has a box-shaped structure (70) comprising wall elements (72, 74, 76, 78), and wherein at least one of the wall elements (72, 74, 76, 78) of the box-shaped structure (70) has extensions (92, 94, 112, 114, 142, 144, 146, 148) which extend in one piece from it into the support elements (54, 56) and form a structural element of the support elements (54, 56).

2. A crossmember in accordance with embodiment 1, wherein at least two mutually opposite wall elements of the box-shaped structure (70) extend with their extensions (92, 94, 112, 114, 142, 144, 146, 148) in one piece into the support elements (54, 56) and form at least parts of the structure of the support elements (54, 56).

3. A crossmember in accordance with embodiment 2, wherein at least three wall elements (72, 74, 76, 78) of the box-shaped structure (70) extend with their extensions (92, 94, 112, 114, 142, 144, 146, 148) in one piece into the support elements (54, 56) and form at least parts of the structure of the support elements (54, 56).

4. A crossmember in accordance with the preceding embodiments, wherein all wall elements (72, 74, 76, 78) of the box-shaped structure (70) extend with their extensions (92, 94, 112, 114, 142, 144, 146, 148) in one piece into the support elements (54, 56) and form at least part of the structure, in particular the structure, of the support elements (54, 56).

5. A crossmember in accordance with the preceding embodiments, wherein one of the wall elements (72) extending in one piece into the support elements (54, 56) forms with its extensions (92, 94) in each of the support elements (54, 56) at least one support surface (106, 108) of the crossmember (20), which support surface is placeable against one of the support regions (64, 66) of the vehicle rear (14).

6. A crossmember in accordance with embodiment 5, wherein the wall element (72) is the vehicle-facing wall element (72) of the box structure (70).

7. A crossmember in accordance with embodiments 5 or 6, wherein the support surfaces (106, 108) of the crossmember (20) are arranged offset in relation to the central unit (52) in the direction of the vehicle rear (14).

8. A crossmember in accordance with embodiments 5 to 7, wherein the central unit (52) is arranged relative to the support surfaces (106, 108) of the support elements (54, 56) such that it runs, in particular with its vehicle-facing wall element (72), at a spacing from the vehicle rear (14) when the support surfaces (106, 108) abut against the support regions (64, 66).

9. A crossmember in accordance with embodiments 5 to 8, wherein the wall element (72) with its extensions (92, 94) forms support plates (102, 104) having the support surfaces (106, 108).

10. A crossmember in accordance with embodiment 9, wherein the extensions (92, 94) form bends (96, 98, 112, 114, 132, 134, 136, 138) which adjoin the support plates (102, 104) and stiffen them.

11. A crossmember in accordance with embodiment 9 or 10, wherein the support plates (102, 104) are connected to the wall element (72) in the region of the box structure (70) by inner bends (96, 98) formed by the extensions (92, 94).

12. A crossmember in accordance with embodiment 11, wherein the support plates (102, 104) are connected to outer bends (112, 114) on their sides opposite the inner bends (96, 98).

13. A crossmember in accordance with embodiments 10 to 12, wherein the support plates (102, 104) have at least one bend (132, 134, 136, 138) extending approximately parallel to the transverse direction (58).

14. A crossmember in accordance with the preceding embodiments, wherein one of the wall elements (74) of the box-shaped structure (70) forms an impact-absorbing impact element thereof, which forms impact surfaces both in the region of the central unit (52) and in the region of the support elements (54, 56) and transmits impact forces to further wall elements (72, 76, 78) of the box-shaped structure (70) and to the support elements (54, 56).

15. A crossmember in accordance with embodiment 14, wherein the impact-absorbing wall element (74) is itself deformable.

16. A crossmember in accordance with embodiment 14 or 15, wherein the impact-absorbing wall element (74) is the wall element (74) of the box-shaped structure (70) facing away from the vehicle.

17. A crossmember in accordance with embodiments 14 to 16, wherein the impact-absorbing wall element (74) is connected to at least one wall element (76, 78) supporting it approximately parallel to the direction of travel.

18. A crossmember in accordance with embodiment 17, wherein the at least one wall element (76, 78) supporting approximately parallel to the direction of travel is connected to the vehicle-facing wall element (72).

19. A crossmember in accordance with embodiment 17 or 18, wherein the box-shaped structure (70) has two wall elements (76, 78) which act in a supporting manner approximately parallel to the direction of travel and are arranged at a spacing from one another.

20. A crossmember in accordance with embodiments 17 to 19, wherein at least one wall element (76) acting in a supporting manner in the direction of travel is a roadway-facing wall element (76) of the crossmember (20).

21. A crossmember in accordance with embodiments 17 to 20, wherein the at least one wall element (78) acting in a supporting manner in the direction of travel is a wall element (78) of the crossmember facing away from the roadway.

22. A crossmember in accordance with the preceding embodiments, wherein the at least one wall element (76, 78) acting in a supporting manner in the direction of travel is supported both in the region of the central unit (52) and in the region of the support elements (54, 56).

23. A crossmember in accordance with embodiments 17 to 22, wherein the at least one wall element (76, 78) acting in a supporting manner approximately parallel to the direction of travel is deformable for absorbing impact energy.

24. A crossmember in accordance with the preceding embodiments, wherein the at least one wall element (76, 78) acting in a supporting manner approximately parallel to the direction of travel is supported in the region of the support elements (54, 56) by its one-piece extensions (142, 144, 146, 148) on the support plates (102, 104).

25. A crossmember in accordance with embodiment 24, wherein the at least one wall element (76, 78) acting in a supporting manner approximately parallel to the direction of travel is supported in a planar manner by its one-piece extensions (142, 144, 146, 148) on the support plates (102, 104) by means of support flanges (152, 154, 156, 158).

26. A crossmember in accordance with embodiment 25, wherein the support flanges (152, 154, 156, 158) together with the support plates (102, 104) are connectable to the support regions (64, 66) of the vehicle rear (14) by means of mounting elements (162, 164) acting on both.

27. A crossmember in accordance with embodiments 19 to 26, wherein the one-piece extensions (142, 144, 146, 148) of the at least one wall element (76, 78) acting in a supporting manner approximately parallel to the direction of travel form a hollow body (302, 304, 306, 308) stiffening said wall element.

28. A crossmember in accordance with embodiment 27, wherein in each case a hollow body (302, 304, 306, 308) is formed as a support body and is supported on one of the support plates (102, 104).

29. A crossmember in accordance with embodiment 28, wherein each hollow body (302, 304, 306, 308) extends in the direction of the corresponding support plate (102, 104) with an increasingly widening cross-section.

30. A crossmember in accordance with embodiment 28 or 29, wherein the hollow body (302, 304, 306, 308) is formed as a semi-pyramid.

31. A crossmember in accordance with embodiments 24 to 30, wherein the hollow body (302, 304, 306, 308) is formed by bending of the corresponding extension (142, 144, 146, 148) at least three times.

32. A crossmember in accordance with embodiments 27 to 31, wherein each hollow body (302, 304, 306, 308) is supported by flange elements (312, 314, 316, 318, 322, 324, 326, 328) on the corresponding support plate (102, 104).

33. A crossmember in accordance with embodiment 32, wherein the flange elements (312, 314, 316, 318, 322, 324, 326, 328) together with the corresponding support plate (102, 104) are connectable to the support regions (64, 66) of the vehicle rear (14) by means of mounting elements (162, 164) acting on both.

34. A crossmember in accordance with the preceding embodiments, wherein the box-shaped structure (70) has at least one wall element (72, 74, 76, 78) which is provided with at least one cut-out (372, 374, 376, 384, 392, 394, 402, 404).

35. A crossmember in accordance with embodiment 34, wherein the at least one cut-out (372, 374, 376, 378, 384, 392, 394, 402, 404) has an areal extent which corresponds in each direction to a maximum of 2 times the areal extent of a surface region (373, 375, 377, 383, 385, 393, 403, 405) surrounding it in the corresponding direction.

36. A crossmember in accordance with embodiment 34 or 35, wherein the at least one cut-out (372, 374, 376, 384, 392, 394, 402, 404) is surrounded on all sides by the surface region (373, 375, 377, 383, 385, 393, 403, 405).

37. A crossmember in accordance with embodiments 34 to 36, wherein the at least one cut-out (372, 374, 376, 384, 392, 394, 402, 404) has an outer contour with a substantially round and/or oval basic shape.

38. A crossmember in accordance with embodiments 34 to 37, wherein the at least one cut-out (402, 404), with respect to the surface region (403, 405) surrounding it, has an edge region (412, 414) which is raised relative to this surface region (403, 405).

39. A crossmember in accordance with embodiment 38, wherein the raised edge region (412) has a height transverse to the surface region (403) surrounding it which corresponds to at least twice a material thickness of the surface region (403) surrounding it.

40. A crossmember in accordance with the preceding embodiments, wherein at least some of the wall elements (72, 74, 76, 78) of the box-shaped structure (70), as a result of re-shaping, have an increased rigidity against deformation.

41. A crossmember in accordance with embodiment 40, wherein at least one of the wall elements (72, 74, 76, 78) of the box-shaped structure (70) has a bending line (88) running approximately parallel to the vertical longitudinal center plane (FL).

42. A crossmember in accordance with embodiment 40 or 41, wherein at least one of the wall elements (72, 74, 76, 78) has at least one embossed bead (172, 174).

43. A crossmember in accordance with embodiment 42, wherein at least one of the walls (72, 74, 76, 78) has at least one embossed bead (172, 174) which extends in a transverse direction (58) with respect to the vertical longitudinal center plane (FL).

44. A crossmember in accordance with the preceding embodiments, wherein the central unit (52) is formed in such a way that a hitch element (40) for a trailer or a load carrier is mountable on it, and in that the forces transmitted by the hitch element (40) to the central unit (52) are transmitted from the central unit (52) to the support elements (54, 56) and from these to the support regions (64, 66) of the vehicle rear (14).

45. A crossmember in accordance with embodiment 44, wherein the box-shaped structure (70) of the central unit (52) carries a receiving unit (220) for the hitch element (40).

46. A crossmember in accordance with embodiment 45, wherein the receiving unit (220) for the hitch element (40) is arranged in the central unit (52).

47. A crossmember in accordance with embodiments 44 to 46, wherein the receiving unit (220) for the hitch element (40) is arranged in an interior (82) of the central unit (52).

48. A crossmember in accordance with embodiment 47, wherein a roadway-facing wall (76) of the central unit (52) has an opening (84) through which the hitch element (40) with the mounting unit (220) is insertable into the interior (82).

49. A crossmember in accordance with embodiments 44 to 48, wherein the hitch element (40) in its working position (A) reaches through the opening (84).

50. A crossmember in accordance with embodiments 44 to 49, wherein the hitch element (40) in a rest position (R) is arranged substantially in the interior (82) of the box-shaped structure (70) of the central unit (52).

Further features and advantages of the invention are the subject of the following description and the graphical depiction of a number of exemplary embodiments.

### BRIEF DESCRIPTION OF THE DRAWINGS

FIG. 1 shows a side view of a motor vehicle with a crossmember according to the invention, which is provided with a trailer hitch, wherein the side view is shown partially broken away in the region of the crossmember;

FIG. 2 shows a perspective view in the direction of travel of a crossmember according to a first exemplary embodiment;

FIG. 3 shows a plan view of the crossmember in the direction of travel according to the first exemplary embodiment;

FIG. 4 shows a plan view of a side of the crossmember according to the invention facing away from the roadway according to the first exemplary embodiment;

FIG. 5 shows a perspective view, opposite to the direction of travel, of the crossmember according to the invention according to the first exemplary embodiment;

FIG. 6 shows a plan view, opposite to the direction of travel, of the crossmember according to the invention according to the first exemplary embodiment;

FIG. 7 shows a plan view of a roadway-facing side of the crossmember according to the first exemplary embodiment;

FIG. 8 shows a plan view similar to FIG. 4 of the first exemplary embodiment of the crossmember according to the invention with the wall element facing away from the roadway broken away, provided with a pivotable hitch element in the working position;

FIG. 9 shows a perspective view of the crossmember according to the invention according to the first exemplary embodiment in accordance with FIG. 5 with the pivotable hitch element in the working position;

FIG. 10 shows a perspective view of the crossmember according to the invention according to the first exemplary embodiment in accordance with FIG. 9 with the pivotable hitch element in the rest position;

FIG. 11 shows a plan view corresponding to FIG. 4 of the crossmember according to the first exemplary embodiment, with the wall element facing away from the roadway partially broken away, shown with a removable hitch element;

FIG. 12 shows a perspective view in the direction of travel of a support element according to a second exemplary embodiment of the crossmember according to the invention;

FIG. 13 shows a perspective view in the direction of travel similar to FIG. 12 of the second exemplary embodiment of the crossmember according to the invention with the wall element facing away from the vehicle removed;

FIG. 14 shows a perspective view in the direction of travel similar to FIG. 2 according to a third exemplary embodiment of a crossmember according to the invention;

FIG. 15 shows a plan view in the direction of travel of the third exemplary embodiment of the crossmember according to the invention;

FIG. 16 shows a perspective view of the third exemplary embodiment of the crossmember according to the invention provided with a hitch element in the working position;

FIG. 17 shows a perspective view similar to FIG. 2 of a fourth exemplary embodiment of a crossmember according to the invention;

FIG. 18 shows a plan view in the direction of travel of the fourth exemplary embodiment of the crossmember according to the invention, similar to FIG. 2;

FIG. 19 shows a plan view of a roadway-facing side of the fourth exemplary embodiment of the crossmember according to the invention, similar to FIG. 7;

FIG. 20 shows a plan view of a side of the fourth exemplary embodiment of the crossmember according to the invention facing away from the roadway, similar to FIG. 4;

FIG. 21 shows a perspective view of a left support element of the crossmember according to the invention according to the fourth exemplary embodiment;

FIG. 22 shows a plan view of a vehicle-facing side similar to FIG. 7 of the fourth exemplary embodiment of the crossmember according to the invention, provided with a pivotable hitch element in the working position;

FIG. 23 shows a perspective view similar to FIG. 2 of a fifth exemplary embodiment of a crossmember according to the invention with a pivotable hitch element;

FIG. 24 shows a view similar to FIG. 9 of the fifth exemplary embodiment of a crossmember according to the invention with the pivotable hitch element;

FIG. 25 shows a perspective view similar to FIG. 23 of a sixth exemplary embodiment of the crossmember according to the invention provided with a hitch element in the working position; and

FIG. 26 shows a section along line 26-26 in FIG. 25.

### DETAILED DESCRIPTION OF THE INVENTION

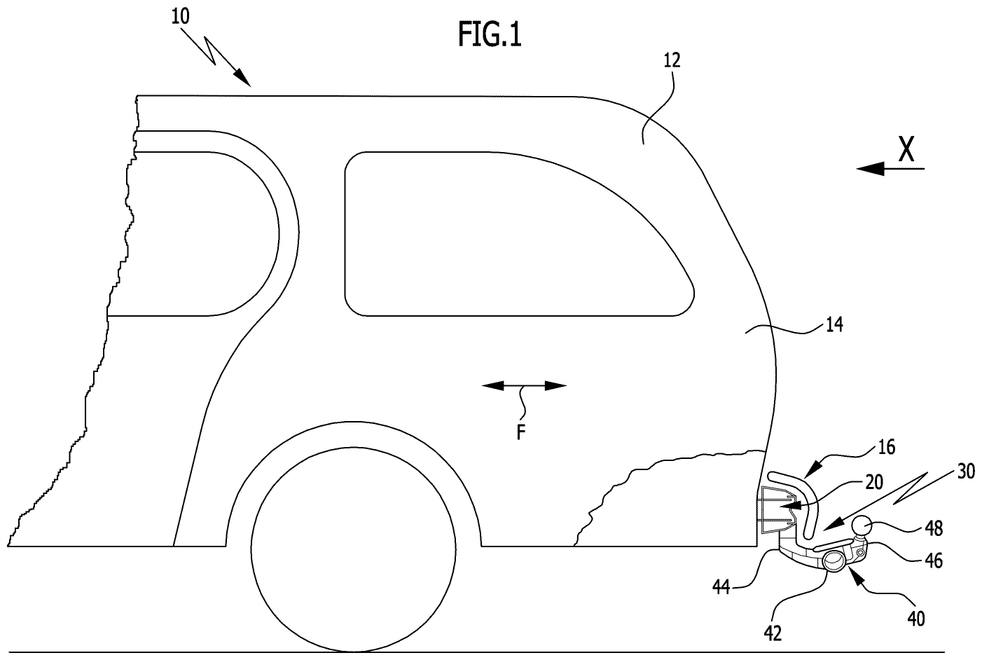

The invention is for use on a motor vehicle 10 which has a vehicle body 12 which carries a bumper unit designated as a whole by 16 on a vehicle rear 14, as shown in FIG. 1.

Concealed by the bumper unit 16, an impact-absorbing crossmember designated as a whole by 20 is arranged on the vehicle rear 14 and can be part of a trailer hitch designated as a whole by 30 or can be extended to form a trailer hitch designated as a whole by 30, if, in addition, a hitch element 40, in particular formed as a ball neck 42, is provided on the impact-absorbing crossmember 20, which ball neck extends from a first end 44, which is connected to the impact-absorbing crossmember 20, to a second end 46, which carries a coupling element 48, for example formed as a coupling ball.

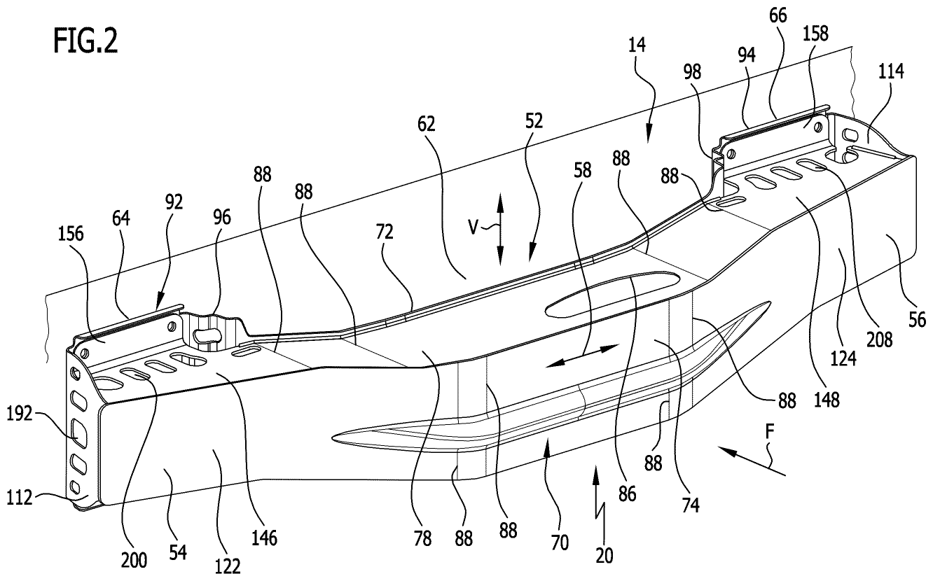

As shown in FIG. 2, the impact-absorbing crossmember 20 comprises a central unit 52, which extends in a transverse direction 58 running approximately parallel to the bumper unit 16, in particular transversely to a vertical vehicle longitudinal center plane FL, and is provided with support elements 54, 56 arranged on both sides of the central unit 52.

The support elements 54 and 56 are supported here on support regions 64, 66 of the vehicle rear 14, wherein a central portion 62 of the vehicle rear 14 lying between the support regions 64, 66 is not intended or suitable for absorbing forces in the event of a crash, so that all the force in the event of a crash is introduced by means of the support regions 64 and 66.

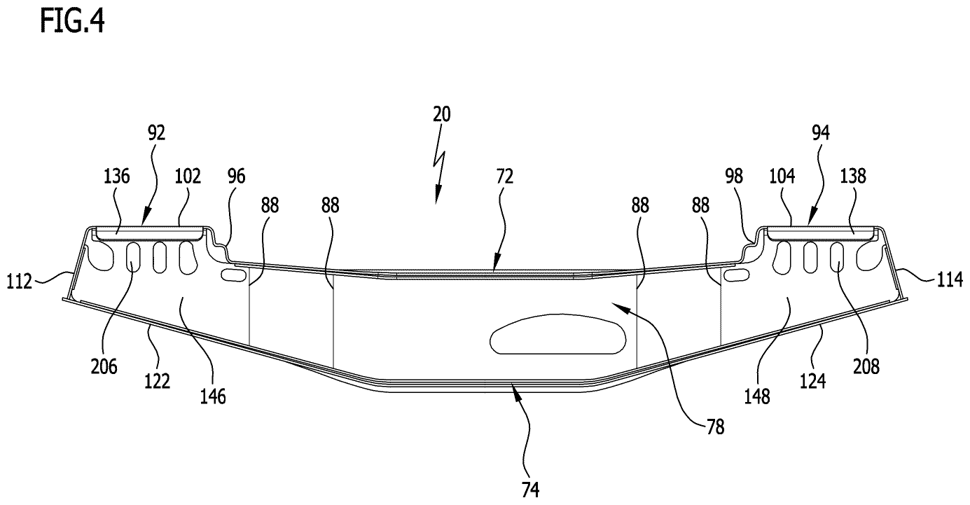

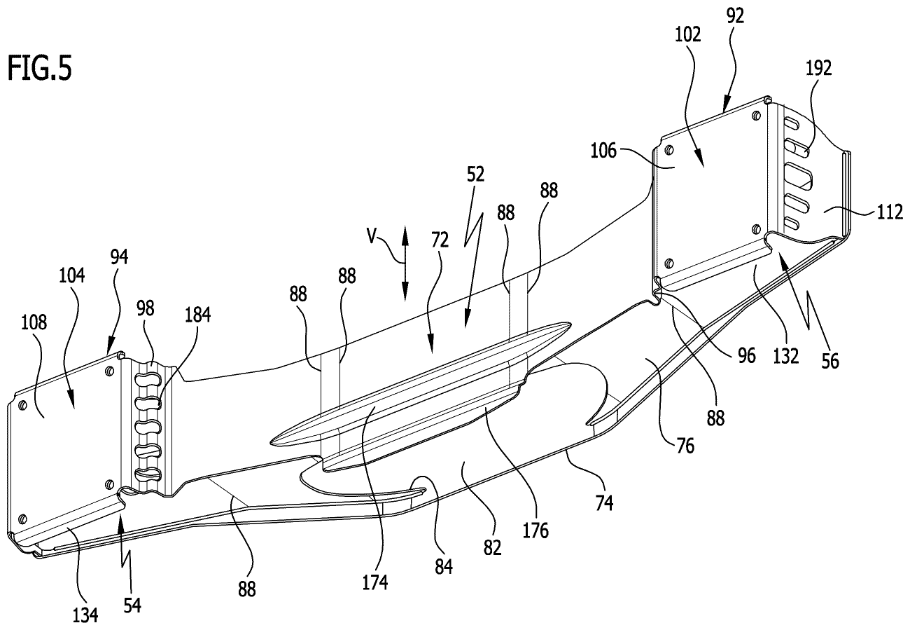

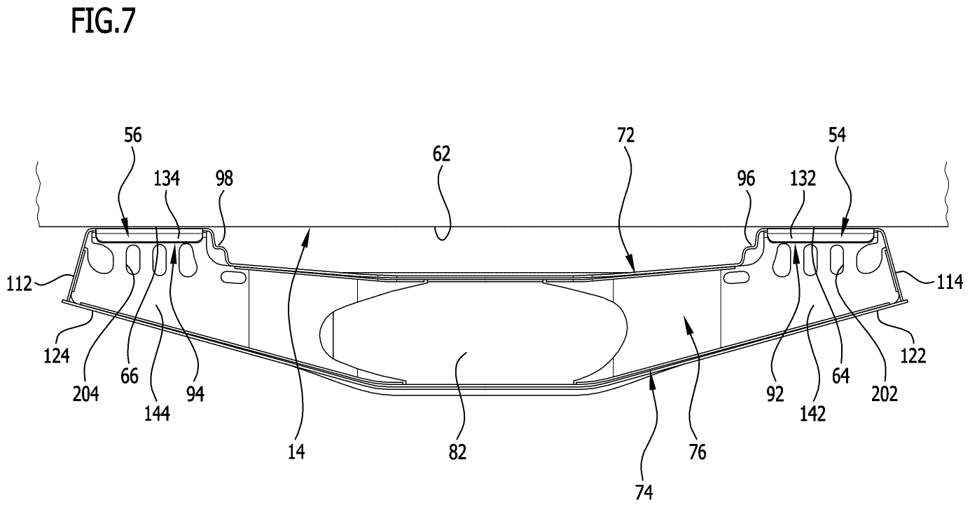

As shown in FIGS. 2 to 7, the central unit 52 has a box-shaped structure 70 formed of a vehicle-facing wall element 72, a wall element 74 facing away from the vehicle, a roadway-facing wall element 76 and a wall element 78 facing away from the roadway, wherein the wall elements 72, 74, 76, 78, as shown in FIGS. 5 and 7, enclose an interior 82 of the box-shaped structure 70.

The box-shaped structure 70 is preferably oriented such that the vehicle-facing wall element 72 extends at least in the region of the central unit 52 at a spacing from and approximately parallel to the vehicle rear 14 and, in particular, approximately, i.e. at an angle of ±maximum 30°, parallel to a vertical V.

In the same way, the wall element 74 facing away from the vehicle also runs approximately parallel to the vertical V, i.e., at an angle of at most ±30°, but at a spacing from the vehicle-facing wall element 72.

The roadway-facing wall element 76 and the wall element 78 facing away from the roadway run transversely to the vehicle-facing wall element 72 and the wall element 74 facing away from the vehicle and extend between them and at a spacing from one another, wherein the roadway-facing wall element 76 and the wall element 78 facing away from the roadway extend approximately parallel to the direction of travel, i.e., at an angle of ±maximum 30° to the direction of travel, and support the vehicle-facing wall element 72 and the wall element 74 facing away from the vehicle relative to one another.

Furthermore, for example, the roadway-facing wall element 76 has an access opening 84 to the interior 82 and the wall element 78 facing away from the roadway is preferably also provided with an opening 86, which is accessible from the interior 82 of the box-shaped structure.

Additional stiffening of the wall elements 72, 74, 76, 78 is achieved in that these are provided with bending lines 88 running approximately parallel to the vertical longitudinal center plane FC.

To form the structure of the support elements 54, 56, as shown in FIGS. 5 to 7, the vehicle-facing wall element 72 is provided with extensions 92, 94 which are integrally formed in one piece thereon and which, starting from the vehicle-facing wall element 72 in the direction of the vehicle rear 14, have inner bends 96, 98 which are preferably formed in two stages and which are adjoined by support plates 102, 104 of the extensions 92, 94, which form support surfaces 106, 108 which run parallel to the support regions 64, 66 provided in the vehicle rear 14 in order to be supported on these in a planar manner.

To stabilize the support plates 102 and 104, the extensions 92, 94 are also provided at their outer ends opposite the inner bends 96, 98 with outer bends 112 and 114 running away from the support surfaces 106, 108 in the direction of the wall element 74 facing away from the vehicle, which outer bends in turn are firmly connected to one-piece extensions 122, 124 of the wall element 74 facing away from the vehicle extending into the support elements 54, 56.

This connection of the extensions 92 and 94 of the vehicle-facing wall element 72 with the extensions 122 and 124 of the vehicle-facing wall element 72 thus forms part of the structure of the support elements 54, 56.

For further stabilization of the support plates 102, 104, these are provided with lower bends 132 and 134 extending between the inner bends 96 and 98 and the corresponding outer bends 112 and 114 and preferably running approximately parallel to the transverse direction 58, i.e., at an angle of at most ±30°, as well as upper bends 136 and 138, so that the support plates 102 and 104 as a whole are stabilized by the bends 96 and 98 and 112 and 114, respectively, which extend approximately parallel to the vertical direction V, i.e., at an angle of at most ±30°, as well as by the bends 132 and 134 and 136 and 138, respectively, extending transversely to the vertical direction V, and are thus overall dimensionally stable and thus capable of transmitting the forces acting on the crossmember 20 over a large area to the support regions 64 and 66 of the vehicle rear 14.

The vehicle-facing wall element 72 and the wall element 74 facing away from the vehicle are additionally stiffened relative to one another by the roadway-facing wall element 76 and the wall element 78 facing away from the roadway, which extend between them approximately parallel, i.e., at an angle of at most ±30°, to a direction of travel F and also have one-piece extensions 142 and 144 and 146 and 148, respectively, which extend from the extensions 122 and 124 to the extensions 92, 94, in particular their support plates 102 and 104, and abut on the support plates 102 and 104, specifically on the sides opposite the support surfaces 106 and 108, with bent-over support flanges 152, 154 and 156, 158, respectively, running parallel to the support plates 102 and 104.

Preferably, the support flanges 152, 154 and 156, 158 are formed such that the same mounting elements 162 and 164, for example screws, which are used to mount the support plates 102 and 104 to the support regions 64, 66 also pass through the support flanges 152, 154 and 156, 158, so that these mounting elements 162, 164 are used to connect the support flanges 152, 154 and 156, 158 both to the support plates 102, 104 and at the same time to the support regions 64, 66 of the vehicle rear 14 when the crossmember 20 is mounted on the vehicle rear 14.

The support elements 54, 56 thus have an overall sufficiently rigid structure due to the extensions 102, 104 of the vehicle-facing wall element 72, the extensions 122 and 124 of the wall element 74 facing away from the vehicle and the extensions 142 and 144 of the roadway-facing wall element 76 and the extensions 146 and 148 of the wall element 78 facing away from the roadway, in order to transmit all forces acting on the crossmember 20, for example in the event of a crash, to the vehicle rear 14, in particular its support regions 64, 66.

In the event of a crash, both in the region of the central unit 52 and in the region of the support elements 54 and 56, depending on the crash impact, a deformation of at least the wall element 74 facing away from the vehicle together with its lateral extensions 122 and 124 and also of the roadway-facing wall element 76 and also of the wall element 78 facing away from the roadway in the region of the central unit 52 and also of the extensions 142, 144 and 146, 148 can take place in order to absorb at least part of the impact energy acting on said wall element by the deformation.

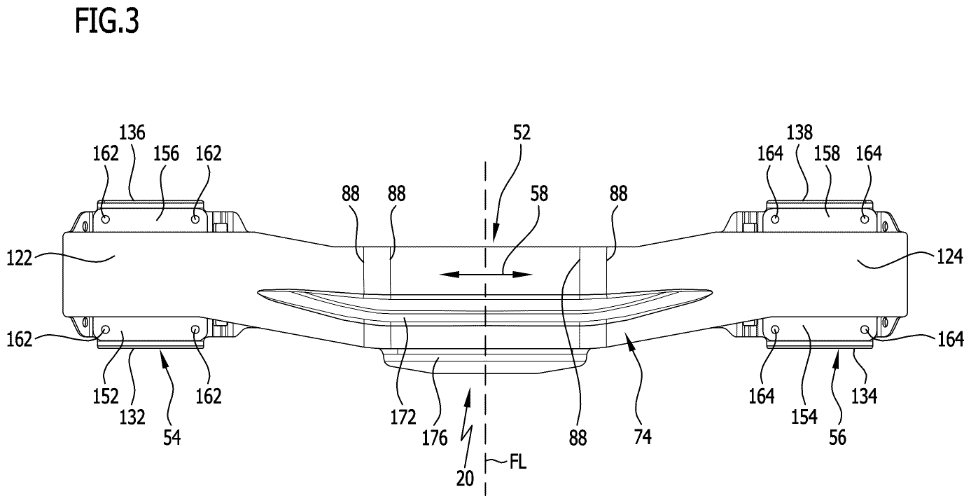

As shown in FIGS. 2 and 3, in order to stiffen the wall element 74 facing away from the vehicle, the latter is provided with a bead 172 which extends between the extensions 122 and 124 substantially over the extent of the central unit 52 in the transverse direction 58 and, in particular, is curved outwards in the direction from the interior 82 of the central unit 52.

The bead 172 is preferably arranged in the wall element 74 facing away from the vehicle near the roadway-facing wall element 76, in order to compensate for the reduced stiffening effect of the wall element 74 facing away from the roadway by the roadway-facing wall element 76 due to the access opening 84 in the roadway-facing wall element 76, and thus to provide sufficient rigidity to the wall element 74 facing away from the vehicle.

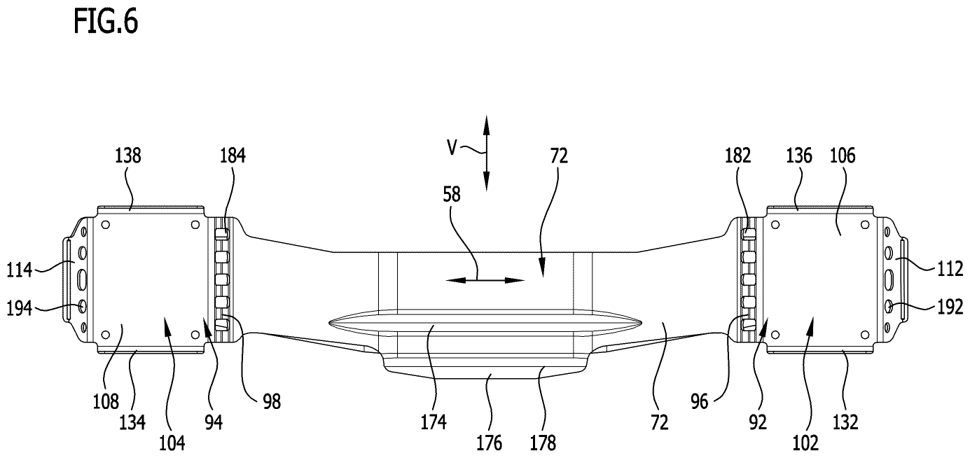

In addition, the vehicle-facing wall element 72, as shown in FIGS. 5 and 6, is also provided with a bead 174, which is bulged in the direction of the vehicle rear 14 and also gives the vehicle-facing wall element 72 increased rigidity.

The bead 174 also extends approximately in the transverse direction 58 in the region of the central unit 52 between its extensions 92 and 94.

Furthermore, the vehicle-facing wall element 72 is provided in the region of its underside facing the roadway with a projection 176 reaching beyond the roadway-facing wall element 76, which also has either bends 178 or beads 178 in order to also provide the vehicle-facing wall element 72 with increased rigidity in the region of the access opening 84.

In order to avoid material fatigue or fractures in the region of the extensions 92, 94 of the vehicle-facing wall element 72 forming the support plates 102 and 104 in the event of varying loads on the impact-absorbing crossmember 20, the bends 96 and 98 in the extensions 92 and 94, as shown in FIGS. 5 and 6, are provided with openings 182 and 184, which give the bends a limited elasticity of movement in order to avoid stress fractures when the forces are transmitted from the support plates 102 and 104 to the crossmember 20, in particular its central unit 52.

Similarly, bends 112 and 114, as shown for example in FIGS. 2, 5 and 6, are also provided with openings 192 and 194 which also provide the bends 112 and 114 with limited bending elasticity to transmit forces from the support plates 102 and 104 to the crossmember 20 and to prevent stress fractures.

In addition, in order to also provide bending elasticity in the extensions 142 and 144 of the roadway-facing wall element 76, which are adjacent to the support plates 102 and 104, these extensions are also provided with openings 202 and 204, as shown, for example, in FIG. 7.

In addition, openings 206 and 208 are also provided in the extensions 146 and 148 of the wall element 78 facing away from the roadway in connection with the support plates 102 and 104 in order to also achieve limited bending elasticity.

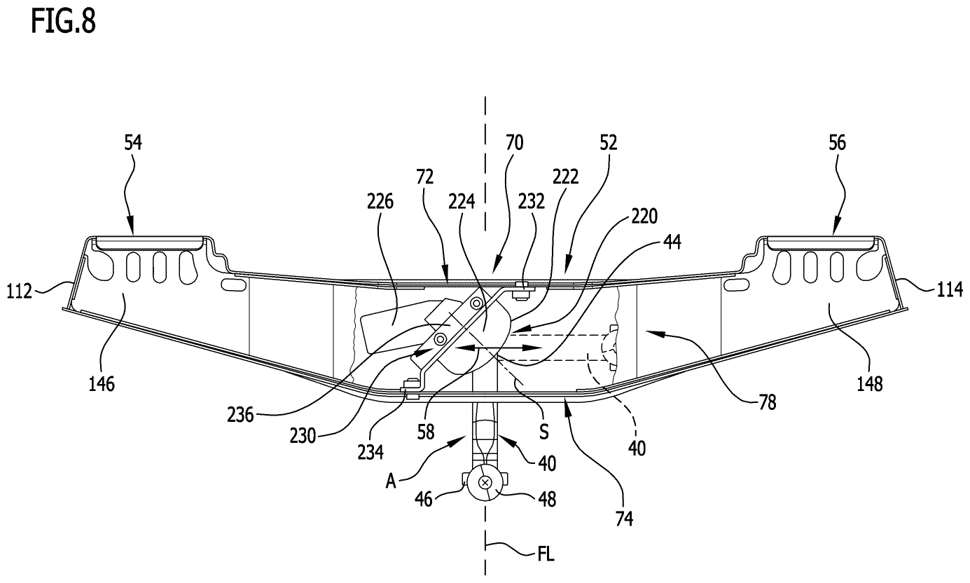

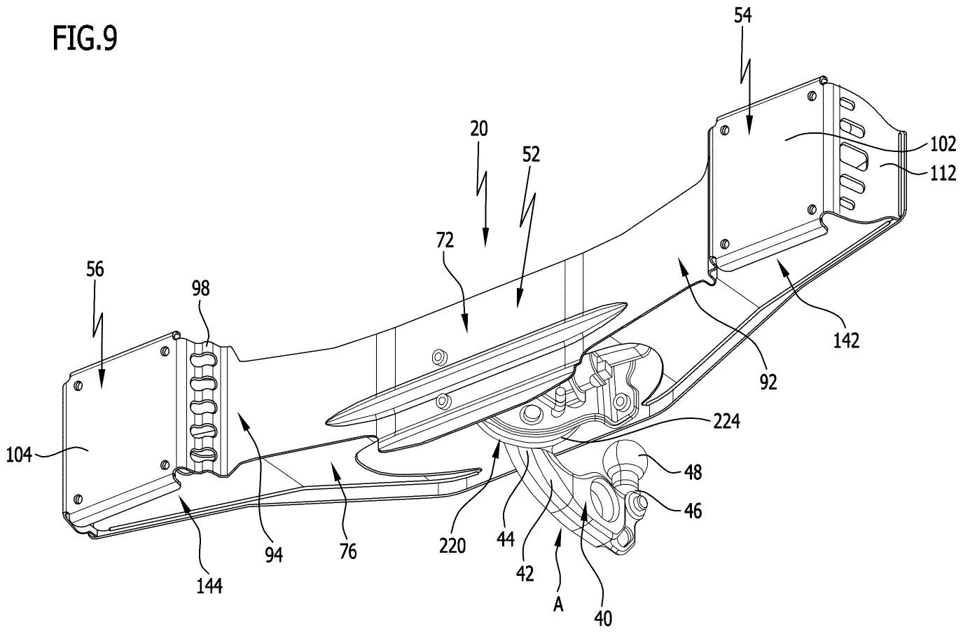

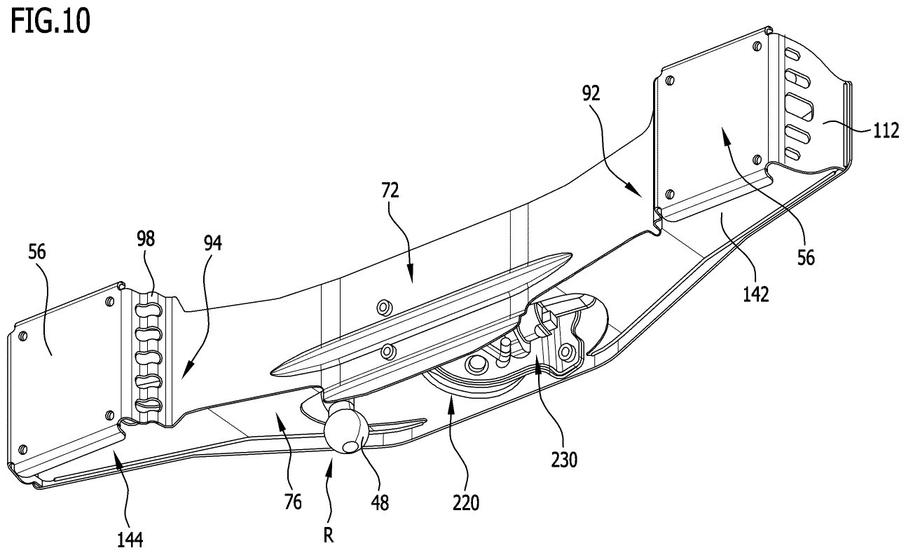

As shown in FIG. 8, in order to extend the impact-absorbing crossmember 20 to the trailer hitch 30 comprising the hitch element 40, the hitch element 40 is provided with a mounting unit for the hitch element 40, which mounting unit is designated as a whole as 220 and, in the embodiment shown in FIGS. 8 to 11, comprises a pivot bearing unit 222 which has a pivot bearing body 224 to which the hitch element 40 is connected with the first end 44, so that, by rotating the pivot bearing body 224 about the pivot axis S, which extends obliquely to the vertical vehicle longitudinal center plane FL of the motor vehicle 10, the hitch element 40 is pivotable from a working position A shown in FIGS. 8 and 9, in which the hitch element 40 extends approximately in the vertical vehicle longitudinal center plane FL, preferably symmetrically with respect thereto, into a rest position R, in which, for example, the hitch element 40, as shown by dashed lines in FIG. 8 and by solid lines in FIG. 10, lies in the interior 82 of the central unit 52, specifically in such a way that the hitch element 40, as shown by dashed lines in FIG. 8, extends from the pivot bearing body 224 approximately, i.e., with an angle of at most plus/minus 30°, parallel to the transverse direction 58, wherein, as shown in FIG. 10, the coupling element 48 points in the direction of the roadway and, for example, projects from the interior 82 through the access opening 84 in the direction of the roadway, while the hitch element 40 lies within the interior 82 and, if necessary, extends into the opening 86.

The pivot bearing unit 222 is still driveable here by a drive motor 226, for example.

For mounting the pivot bearing unit 222 in the interior 82 of the central unit 52, in particular the box-shaped structure 70, the latter is held on a mounting base designated as a whole by 230, wherein the pivot bearing unit 222 passes through the mounting base 230, for example formed as a flange unit, so that, for example, the drive motor 226 is arranged on one side of the mounting base 230 and the pivot bearing body 224 is located on the opposite side.

In particular, in the crossmember 20 according to the invention, the entire mounting unit 220 together with the mounted hitch element 40 and the mounting base 230 is insertable into the interior 82 of the box-shaped structure 70 of the central unit 52 through the access opening 84 in the vehicle-facing wall 76 as shown in FIG. 5, wherein the mounting base 230 has a mounting flange 232 for connection to the vehicle-facing wall element 72 and a mounting flange 234 connectable to the wall element 74 facing away from the vehicle.

In addition, the mounting base 230 is also provided with a mounting flange 236, with which a connection is made to the wall element 78 facing away from the roadway.

Thus, a stable connection between the pivot bearing unit 222 and the box-shaped structure 70 of the central unit 52 can be established by means of the mounting base 230.

The installation position of the mounting base 230 in the box-shaped structure 70 of the central unit 52 is selected as shown in FIGS. 8 and 9, the hitch element 40 then, when it is in the working position A, extends from the pivot bearing body 224 with the first end 44 downwards through the opening 84 of the roadway-facing wall element 76 and extends under the roadway-facing wall element 76 and the wall element 74 facing away from the vehicle in the opposite direction to the direction of travel F, so that the coupling element 48 lies behind the wall element 74 facing away from the vehicle in the working position A in the opposite direction to the direction of travel F, as shown in FIGS. 8 and 9.

However, if the hitch element 40 is pivoted from the working position A to the rest position R, the hitch element 40 together with the coupling element 48 moves under the wall element 74 facing away from the vehicle and from below through the opening 84 in the roadway-facing wall element 76 into the interior 82 of the box-shaped structure 70 of the central unit 52, in which case the hitch element 40 extends from the pivot bearing body 224 between the wall element 74 facing away from the vehicle and the wall element 72 facing toward the vehicle and lies close to the wall element 78 facing away from the roadway.

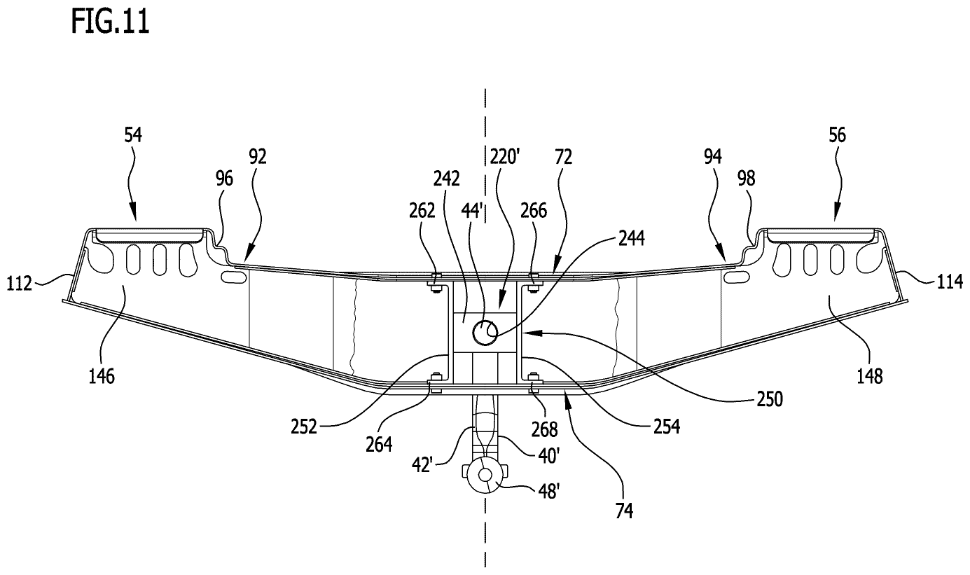

As an alternative to the mounting unit 220 for a pivotable hitch element 40, a further exemplary embodiment, shown in FIG. 11, provides a mounting unit 220′ which has a bearing block 242 which is provided with a receptacle 244 into which a first end 44′ of the hitch element 40′ can be inserted from the roadway side and can be locked in the bearing block 242 by a locking device, which is not shown, so that the entire hitch element 40′ with the first end 44′ and the ball neck 42′ as well as the coupling element 48′ is removable from the bearing block 242 by removing the first end 44′ downwards in the direction of the roadway and can be stored separately in the motor vehicle 10.

For its part, the bearing block 242 can also be mounted on the vehicle-facing wall element 72 and the wall element 74 facing away from the vehicle by means of a mounting base 250, for example in that the mounting base 250 has two flange plates 252 and 254 which receive the bearing block 242 between them, are firmly connected to the bearing block 242 and are in turn connected to the vehicle-facing wall element 72 and the wall element 74 facing away from the vehicle by means of mounting flanges 262, 264 and 266, 268, respectively, in order to be able to mount the entire mounting unit 220′, also if necessary in the interior 82 of the box-shaped structure 70 of the central unit 52, and thus to use the impact-absorbing crossmember 20 as part of the trailer hitch 30.

Since, when the crossmember 20 is used as part of the trailer hitch 30, the forces acting from the trailer element 40 on the vehicle rear 14, in particular the support regions 64 and 66 thereof, are to be transmitted from the central unit 52 to the support elements 54 and 56 and thus ultimately to the support plates 102 and 104, and these forces vary during trailer operation, the flexibility made possible under the action of forces by the openings 182 and 184 in the bends 96 and 98, the openings 192 and 194 in the bends 112 and 114 and the openings 202 and 204 in the extensions 142 and 144 of the roadway-facing wall element 76 and also the openings 206 and 208 in the extensions 146 and 148 of the wall element 78 facing away from the roadway is advantageous in order to prevent fatigue fractures in these regions.

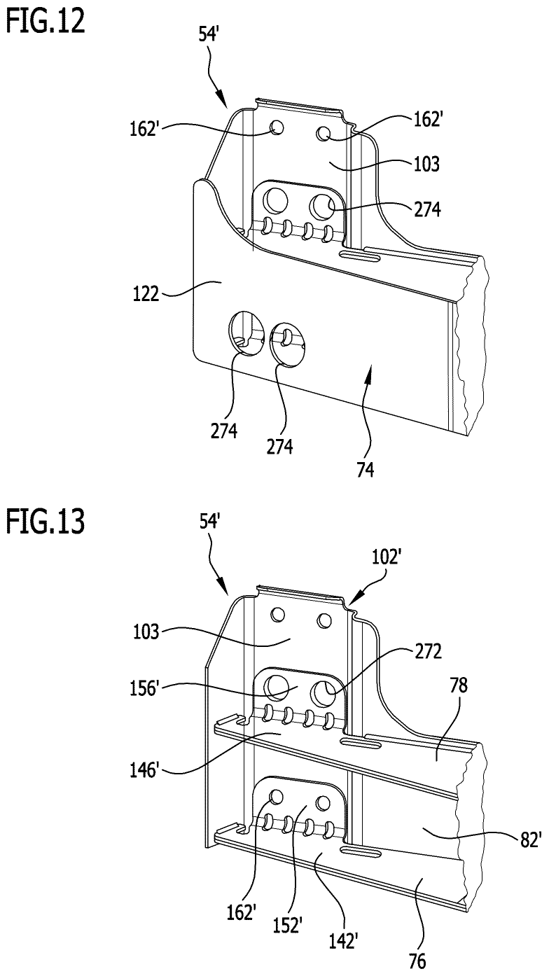

In a second exemplary embodiment of the solution according to the invention, shown in FIGS. 12 and 13, which is a variant of the first exemplary embodiment, the two support elements, shown representatively on a support element 54′, are formed in a modified manner in that the support plates 102′ project at least on one side beyond the upper wall element 78 or the lower wall element 76.

In this case, for example, the lower wall element 76 is provided with a support flange 152′ in the region of its extension 142′, which support flange extends in contact with the support plate 102′ in the direction of the wall element 78 facing away from the roadway and thus lies in the interior 82′ of the box-shaped structure 70 in the region of the support element 54′.

Furthermore, the extension 146′ of the upper wall element 78 is provided with a support flange 156′, which has, for example, apertures 272 by means of which welding to the support plate 102′ takes place.

The support plate 102′ is bolted to the support region 64 by connecting the support flange 152′ together with the support plate 102′ to the support region 64 by means of mounting elements 162′, while the support plate 102′ is also connected to the support region 64 with its region 103 projecting beyond the wall element 78 facing away from the roadway by means of the mounting elements 162′.

The second exemplary embodiment thus has the advantage that the position of the box-shaped structure 70, formed by the central unit 52 and the support elements 54′ and 56′, can thus be varied relative to the position and extent of the support plate 102′.

Furthermore, for mounting the mounting elements 162′, which act on the support flange 152′, the wall element 74 facing away from the vehicle is provided with openings 274, which allow the mounting elements 162′ to be mounted in order to act on the support flange 152′ and the mounting plate 102′.

The fact that in both the first and the second exemplary embodiment the structure of the support elements 54 and 56 is formed by the extensions 92 and 94 of the vehicle-facing wall element, the extensions 122 and 124 of the wall element 74 facing away from the vehicle, the extensions 142 and 144 of the roadway-facing wall element 76 and the extensions 146 and 148 of the element 78 facing away from the roadway, the production of the crossmember according to the invention is considerably simplified due to the reduction in welding operations, and its susceptibility to structural fractures due to loads is also improved.

In addition, the bends 96 and 98, 112 and 114 as well as 132 and 134 and 136 and 138 of the extensions 92, 94 of the vehicle-facing wall element 72 improve the rigidity of the support plates 102 and 104, so that the vehicle-facing wall element 72 and its extensions 92, 94 can be produced from sheet material of which the thickness is less than 2.5 mm, even better 2 mm.

In addition, the support flanges 152 and 154 of the roadway-facing wall element 76 and the support flanges 156 and 158 of the wall element 78 facing away from the roadway also contribute to the further stiffening of the support plates 102 and 104 as well as to the optimum introduction of force into the support plates 102 and 104 due to their areal contact with the support plates 102 and 104.

Thus, for example, the vehicle-facing wall element 72 is only welded to the roadway-facing wall element 76 and the wall element 78 facing away from the roadway primarily in the region of the central unit 52 and the wall element 74 facing away from the vehicle is welded to the roadway-facing wall element 76 and the wall element 78 facing away from the roadway as well as to the bends 112 and 114 of the extensions 92 and 94 of the vehicle-facing wall element 72, which bends face the extensions 122 and 124 of the wall element 74 facing away from the vehicle.

For the rest, reference is made in full to the explanations of the first exemplary embodiment with regard to the other elements of the second exemplary embodiment.

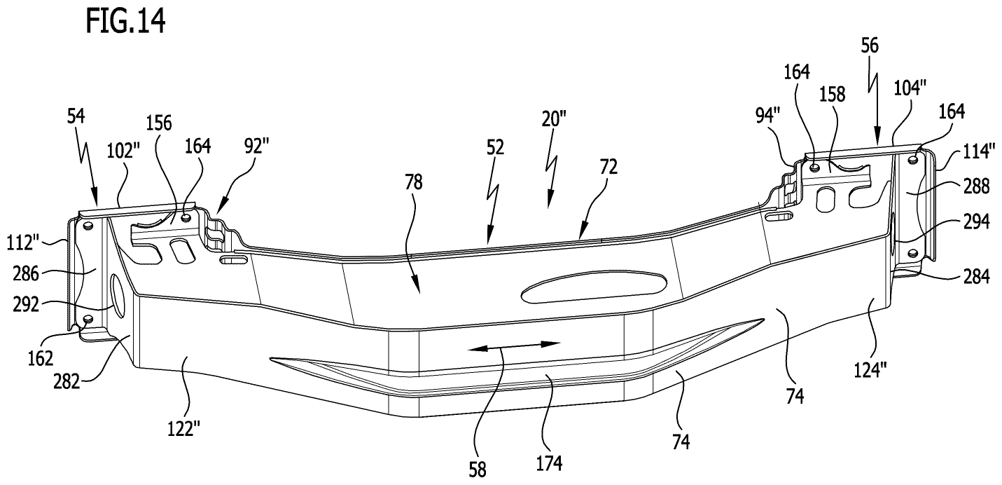

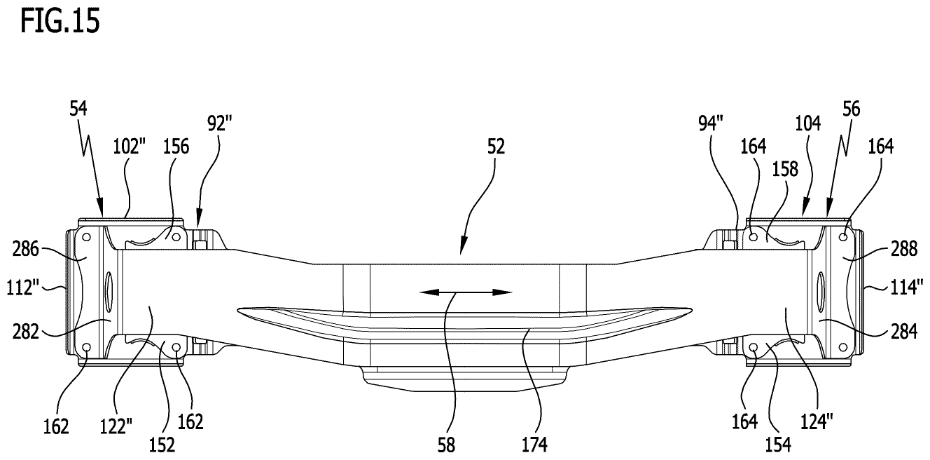

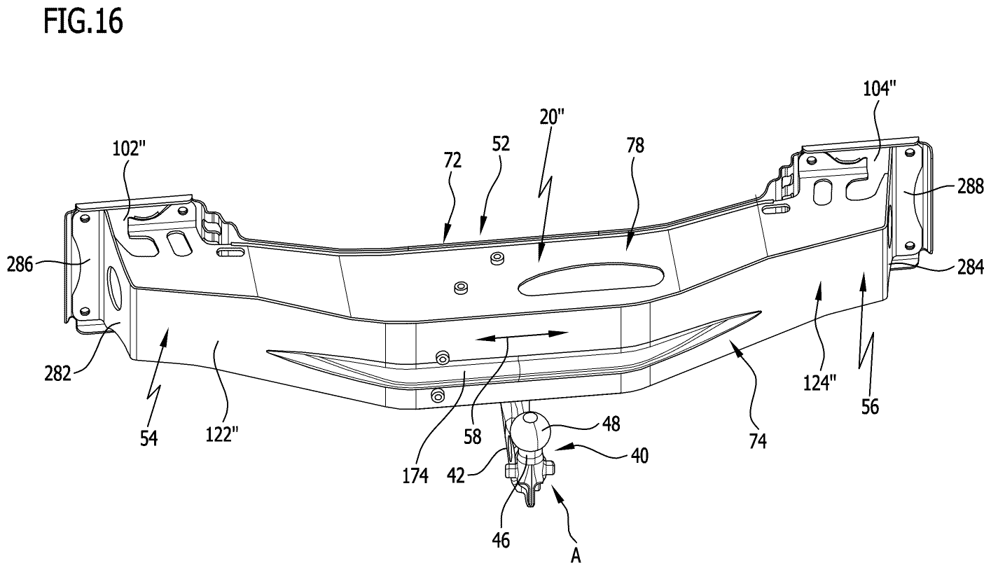

In a third exemplary embodiment, shown in FIGS. 14 to 16, in contrast to the first exemplary embodiment, the extensions 122″ and 124″ are formed in such a way that they have bends 282 and 284 which extend as far as the support plates 102″ and 104″ and have support flanges 286 and 288 which abut in a planar manner against the support plates 102″ and 104″ and with which the extensions 122″ and 124″ are supported directly on the support plates 102″ and 104″.

In contrast, the outer bends 112″ and 114″ of the extensions 92″ and 94″ of the vehicle-facing wall element 72 only extend transversely to the support plates 102″ and 104″, but no longer as far as the extensions 122″ and 124″ of the wall element 74 facing away from the vehicle and, in addition, the bends 112″ and 114″ lie in the transverse direction 58 outside the support flanges 286 and 288 of the outer bends 282 and 284.

Furthermore, the outer bends 282 and 284 are preferably also provided with openings 292 and 294, which give the bends 282 and 284 a certain flexibility in supporting the wall element 74 facing away from the vehicle.

Moreover, in the third exemplary embodiment, the support flanges 286 and 288 are connected to the support plates 102″ and 104″ and also to the support regions 64 and 66 by means of mounting elements 162 and 164 and, in addition, the support flanges 152 and 154 as well as 156 and 158 are also each connected to the respective support plates 102′ and 104′, for example by means of one of the mounting elements 162 and 164.

In the third exemplary embodiment of the crossmember 20″ according to the invention, it is also possible to equip it in the same way as in the first exemplary embodiment with a hitch element 40 and a mounting unit 220 provided in the interior 82 thereof, in the same way as described in conjunction with the first exemplary embodiment, wherein the crossmember 20″ corresponds to the crossmember according to the third exemplary embodiment, which, with regard to the remaining features, has also been described in full in conjunction with the first exemplary embodiment, and so reference is made to that description in full.

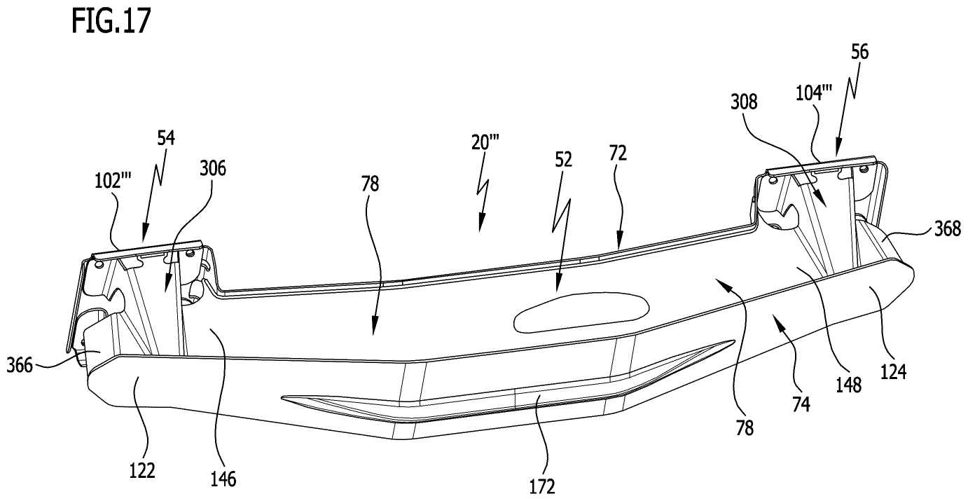

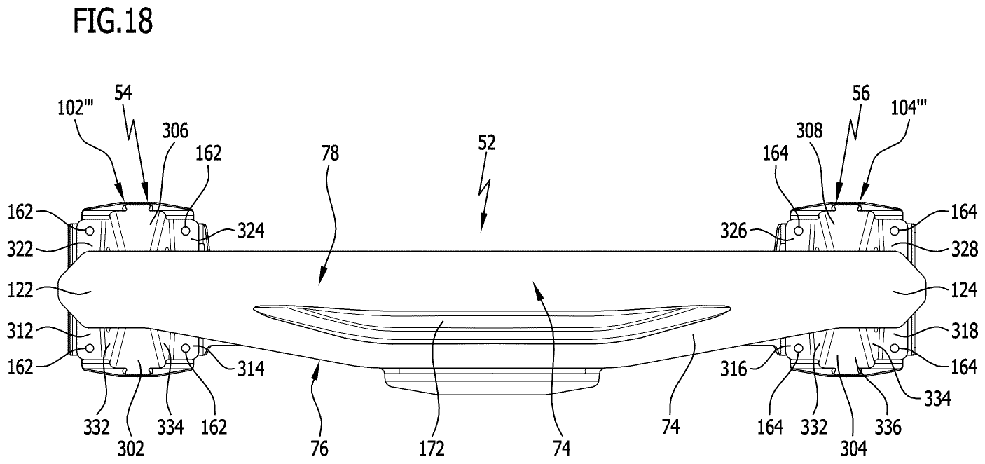

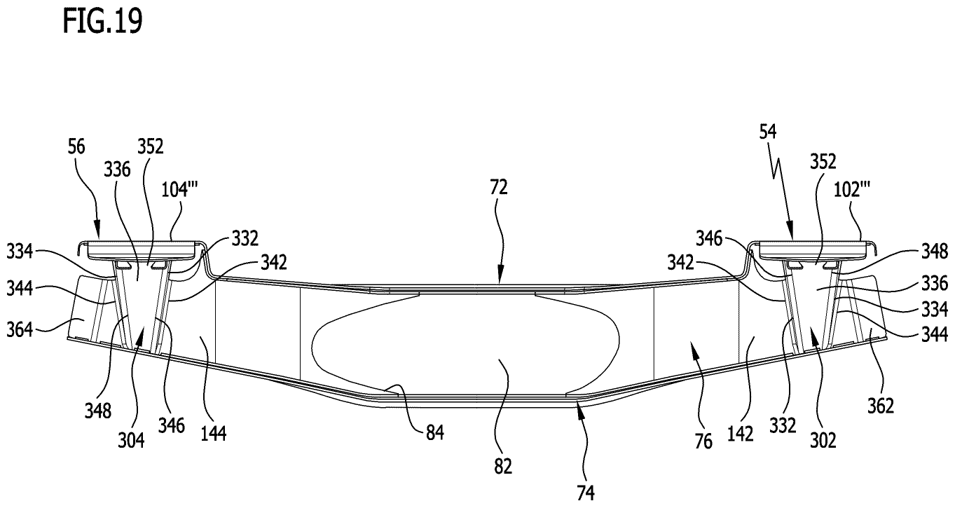

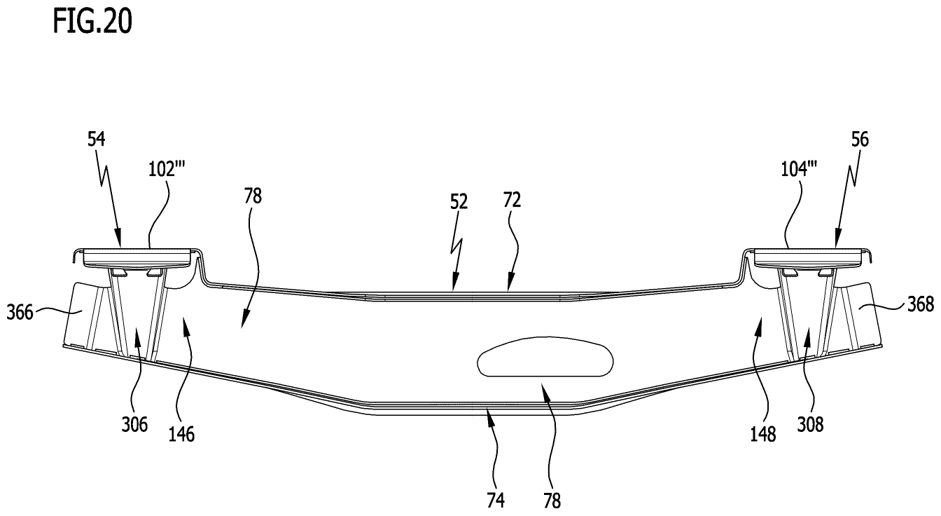

In a fourth exemplary embodiment, shown in FIGS. 17 to 21, those elements which are identical to the preceding exemplary embodiments are provided with the same reference numerals, and therefore reference is made to the explanations of the preceding exemplary embodiments with regard to the description of those elements.

In contrast to the preceding exemplary embodiments, support bodies 302 and 304 and, respectively, 306 and 308 are integrally molded into the extensions 142 and 144 of the roadway-facing wall element 76 and into the extensions 146 and 148 of the wall element 78 facing away from the roadway, in particular are integrally molded in one piece, and in turn are supported on the support plates 102′″ and 104′″ of the support elements 54 and 56 by means of flange elements 312 and 314 in the case of the support body 302, by means of flange elements 316, 318 in the case of the support body 304, by means of flange elements 322 and 324 in the case of the support body 306 and by means of flange elements 326 and 328 in the case of the support body 308.

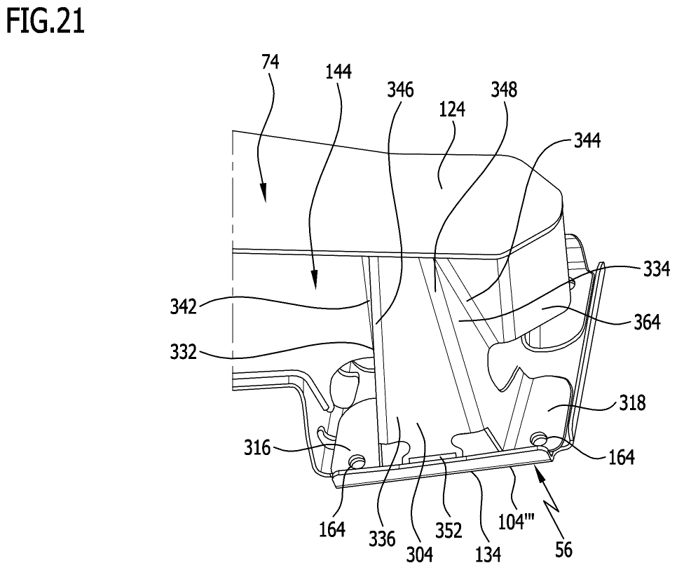

As shown enlarged in particular in FIG. 21 using the example of the support body 304, each of the semi-pyramidal support bodies, in this case the support body 304, comprises two side walls 332, 334 which extend from the corresponding extension 142, 144 or 146, 148 and rise above the corresponding extension 142, 144, 146, 148, in this case the extension 144, and extend in the direction of the respective flange elements 312 or 314 (in the case of the support body 302), 316 or 318 (in the case of the support body 304), 322 or 324 (in the case of the support body 306) and 326 or 328 (in the case of the support body 308), with increasing spacing from one another and merge into the flange elements 312 or 314 (in the case of the support body 302), 316 or 318 (in the case of the support body 304), 322 or 324 (in the case of the support body 306)—and 326 or 328 (in the case of the support body 308).

Furthermore, the side walls of the support bodies 302, 304, 306, 308 are connected to one another by a connecting wall 336 running at a spacing from the corresponding extension 142, 144, 146 and 148, which also runs toward the corresponding extension 142, 144, 146, 148 with increasing spacing in the direction of the corresponding support plate 102′″, 104′″.

Thus, the side walls 332 and 334 together with the connecting wall 336 form a semi-pyramidal support body 302, 304, 306, 308 rising above the corresponding extension 142, 144, 146, 148, with which support body the corresponding roadway-facing wall element 76 and the wall element 78 facing away from the roadway are supported on the support plates 102′″ and 104′″.

Preferably, the side walls 332 are integrally formed in one piece on the corresponding extension 142, 144 or 146, 148 by a bend 342 or 344 and then merge into the connecting wall 336 by a bend 346 and 348, so that the corresponding support body 302, 304, 306, 308 is formed in one piece exclusively by re-shaping the corresponding extension 142, 144, in the case of the roadway-facing wall element 76, and the corresponding extension 146 and 148, in the case of the wall element 78 facing away from the roadway, and thus represents a stiffening for the corresponding extension 142, 144 or 146, 148 itself and, on the other hand, forms an additional structurally rigid support for the corresponding extension 142, 144 or 146, 148 relative to the corresponding support plate 102′″, 104′″.

Furthermore, preferably each connecting wall 336 also has a prolongation 352, with which it is connected to the corresponding bend 132 or 134 and 136 or 138 of the corresponding support plate 102′″, 104′″ in order to achieve further stiffening between the corresponding semi-pyramidal support body 302, 304, 306, 308 and the support plate 102′″ or 104′″.

The flange elements 312 to 318 are, for their part, in turn connected to the support plates 102′″ and 104′″ and the corresponding support region 64 or 66 of the vehicle rear 14 by means of the mounting elements 162 or 164, in order to establish a simple and stable connection to the corresponding support region 64 or 66 on the vehicle rear, which additionally contributes to the stiffening of the corresponding support body 102′″ or 104′″.

In addition, as shown in FIGS. 17 to 21, the extensions 142 and 144 are also provided with bends 362 and 364, respectively, which converge with bends 366 and 368 of the extensions 146 and 148 of the wall element facing away from the vehicle, so that the bends 362 and 346 are in each case connected at the end to the bends 366 and 368 and thus the roadway-facing wall element 76 and the wall element facing away from the roadway form a structure enclosing the interior 82 due to the connections in the region of their extensions 362 and 366 or 364 and 368.

Preferably, the connection between the bends 362 and 366 or 364 and 368 is made as part of a welded connection in the same way as the connection of the wall element 74 facing away from the vehicle to the roadway-facing wall element 76 and the wall element 78 facing away from the roadway is made as part of welded connections.

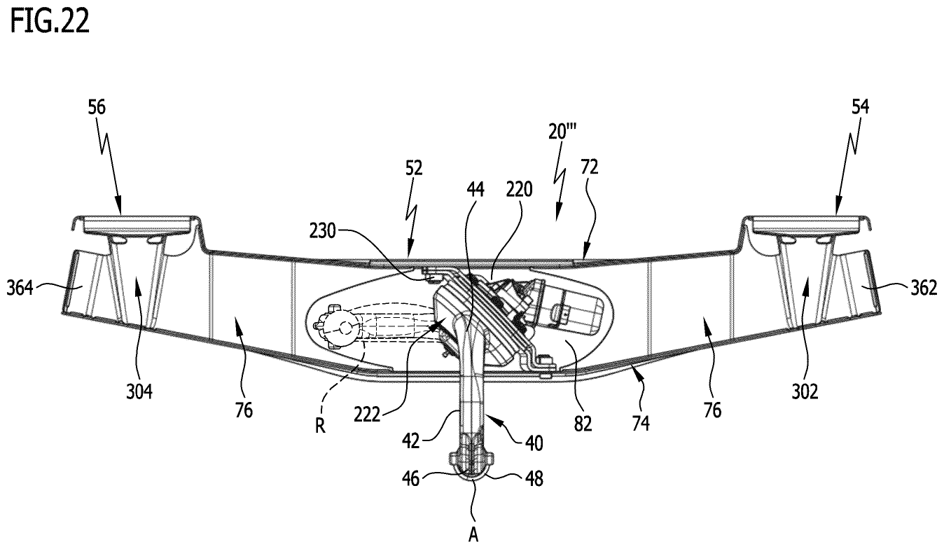

In this exemplary embodiment, as shown in FIG. 22, it is also possible to supplement the crossmember 20′″ by providing a hitch element 40 to form a trailer hitch, wherein the hitch element 40 can be mounted in the interior 82 in the same way with a mounting unit 220 and a mounting base 230 in the same way as shown in the first exemplary embodiment, or alternatively—as not shown in the drawing in FIG. 22—can also be mounted in the interior by providing a mounting base 250.

In the exemplary embodiment shown in FIG. 22, the hitch element 40 is pivotable between a working position A and a rest position R, as also described in conjunction with the first exemplary embodiment, wherein the rest position R is only shown by dashed lines.

With regard to the further features of the fourth exemplary embodiment, insofar as these are identical to the preceding exemplary embodiments, these are provided with the same reference numerals, so that reference is made in full to the explanations in conjunction with the preceding exemplary embodiments.

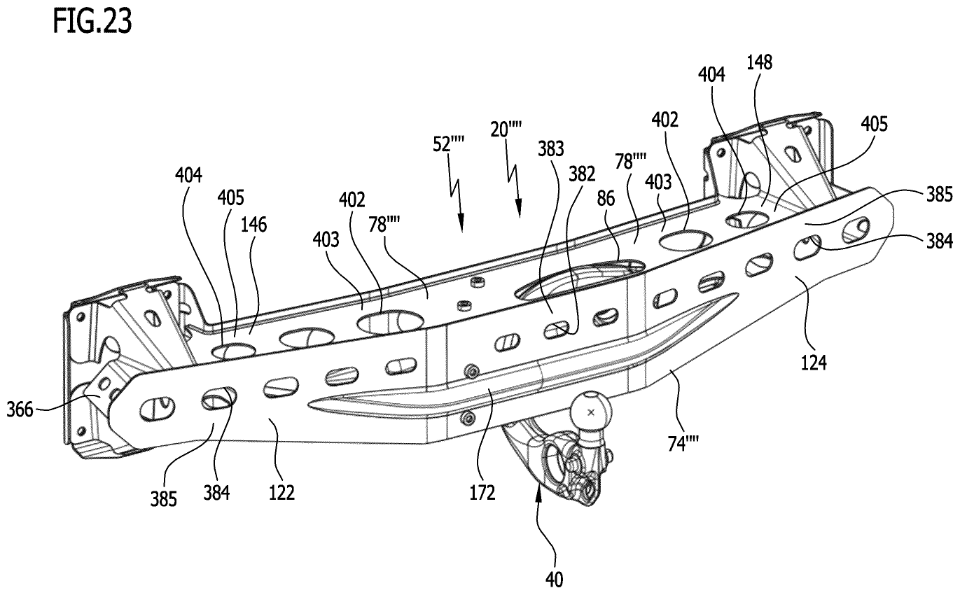

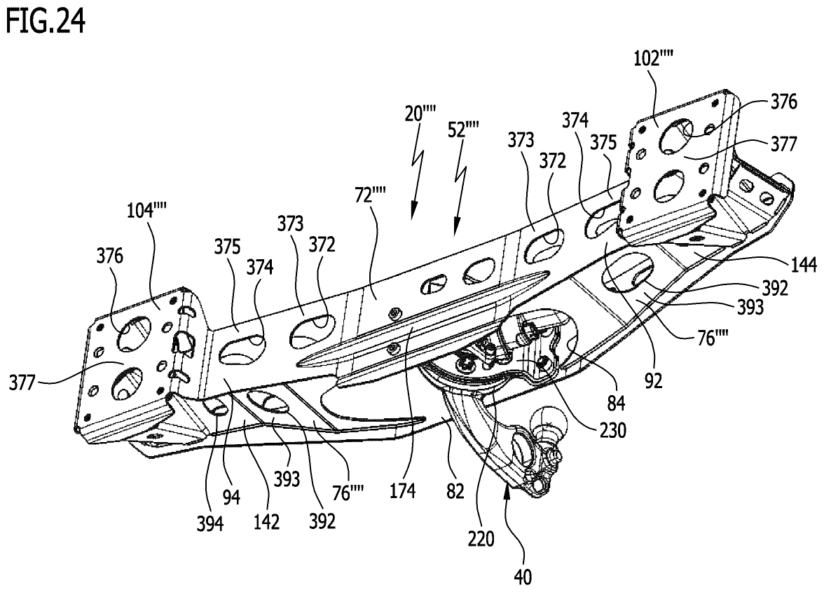

In a fifth exemplary embodiment of a crossmember 20″″, shown in FIG. 23 and FIG. 24, which is based on the basic concept of the crossmember 20″″ according to the third exemplary embodiment, in order to continue the concept of lightweight construction additional cut-outs are provided in the vehicle-facing wall element 72″″ as well as in the wall element 74″″ facing away from the vehicle and also in the roadway-facing wall element 76″″ and the wall element 78″″ facing away from the roadway and lead to additional weight savings.

In particular, cut-outs 372 are provided in the central unit 52″″ in the region of the extent of the bead 174 in the vehicle-facing wall element 72″″, and then cut-outs 374 are also provided at the transition into the extensions 92 and 94, and cut-outs 376 are also provided in the support plates 102″″ and 104″″ (FIG. 24).

In a comparable manner, the wall element 74″″ facing away from the vehicle has successively arranged cut-outs 382 in the region of the central unit 52″″, specifically in the region of the extent of the bead 172, and also cut-outs 384 at the transition into the extensions 122 and 124 (FIG. 23).

The roadway-facing wall element 76″″ also has cut-outs 392 arranged on both sides of the access opening 84, which cut-outs are followed by cut-outs 394 arranged in the extensions 142 and 144.

Finally, the wall element 78″″ facing away from the roadway also has cut-outs 402 on both sides of the opening 86, which cut-outs are followed by cut-outs 404 in the extensions 146 and 148.

In order to avoid a significant impairment of the stability of the wall elements 72, 74, 76, 78 caused by the cut-outs 372, 374, 376, 382, 384, 392, 394, 402, 404, it is provided that their areal extent in each direction of the corresponding wall element 72, 74, 76, 78 corresponds to a maximum of 2 times the areal extent of a surface region 373, 375, 377, 383, 385, 393, 403, 405 surrounding the corresponding cut-out in the corresponding direction.

In the fifth exemplary embodiment as well, the crossmember 20″″ may be provided with a hitch element 40, for example a pivotable hitch element 40, which is held with the mounting unit 220 on a mounting base 230 mounted in the interior 82, as in the preceding exemplary embodiments.

With regard to the other features of the fifth exemplary embodiment, reference is made in full to the preceding exemplary embodiments insofar as these are identical to the preceding exemplary embodiments.

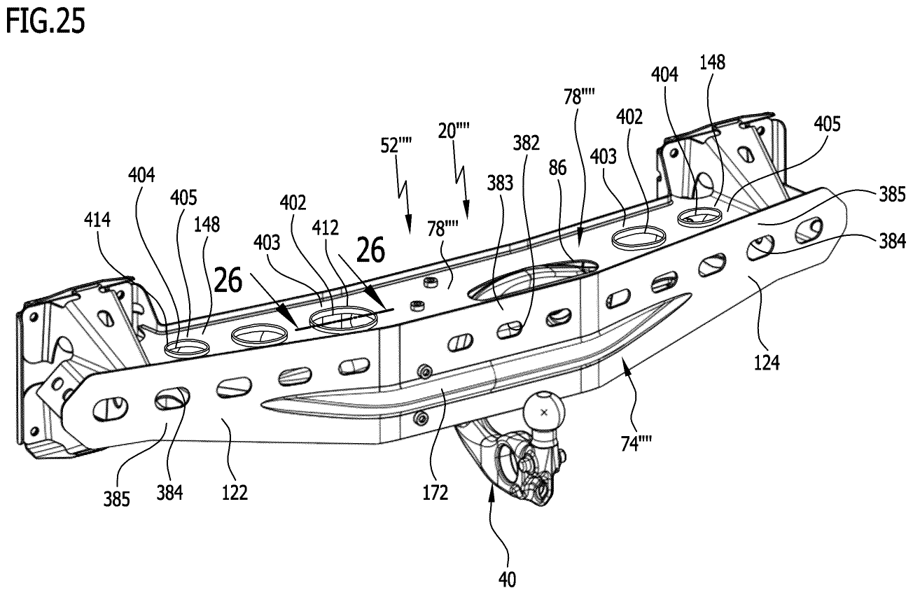

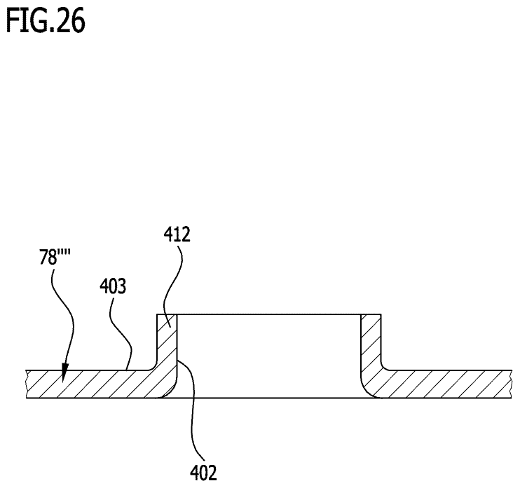

In a sixth exemplary embodiment, shown in FIG. 25 and FIG. 26, for example, the cut-outs 402 and 404 are provided with edge regions 412 and 414 which are raised relative to the surface regions 403, 405 surrounding the cut-outs and which, as shown enlarged using the example of the edge region 412 in FIG. 26, have a height above the surface region 403 which corresponds to at least twice a material thickness of the corresponding surface region 403.

However, such a raised edge region can also be provided for all cut-outs 372, 374, 376, 382, 384, 392, 394, 402, 404.

Furthermore, in the sixth exemplary embodiment, all those elements which are identical to those of the preceding exemplary embodiments are provided with the same reference numerals, so that reference is made in full to the preceding exemplary embodiments in this respect.

All the exemplary embodiments described above are particularly suitable for lightweight embodiments of the crossmember 20, so that the wall elements 72, 74, 76, 78 of the box structure together with the extensions 92, 94, 122, 124, 142, 144, 146, 148 are made of sheets of which the wall thicknesses are smaller than 3.5 mm or less, preferably 3.0 mm or less, even better 2.5 mm or less.

Preferably, the sheets are made of a higher-strength steel with a tensile strength of at least 500 N/m², preferably at least 600 N/m² and even better at least 700 N/m².

1. An impact-absorbing crossmember which is mountable under a bumper unit of a vehicle body on a vehicle rear thereof, wherein the crossmember extends in a transverse direction running approximately parallel to the bumper unit and has support elements arranged at the ends for support on support regions of the vehicle rear, and wherein the support elements are connected to one another by a central unit of the crossmember, wherein the central unit has a box-shaped structure comprising wall elements, and wherein at least one of the wall elements of the box-shaped structure has extensions which extend in one piece from it into the support elements and form a structural element of the support elements.

2. The crossmember in accordance with claim 1, wherein at least two mutually opposite wall elements of the box-shaped structure extend with their extensions in one piece into the support elements and form at least parts of the structure of the support elements.

3. The crossmember in accordance with claim 2, wherein at least three wall elements of the box-shaped structure extend with their extensions in one piece into the support elements and form at least parts of the structure of the support elements.

4. The crossmember in accordance with claim 1, wherein all wall elements of the box-shaped structure extend with their extensions in one piece into the support elements and form at least part of the structure, in particular the structure, of the support elements.

5. The crossmember in accordance with claim 1, wherein one of the wall elements extending in one piece into the support elements forms with its extensions in each of the support elements at least one support surface of the crossmember, which support surface is placeable against one of the support regions of the vehicle rear.

6. The crossmember in accordance with claim 5, wherein the wall element is the vehicle-facing wall element of the box structure.

7. The crossmember in accordance with claim 5, wherein the support surfaces of the crossmember are arranged offset in relation to the central unit in the direction of the vehicle rear.

8. The crossmember in accordance with claim 5, wherein the central unit is arranged relative to the support surfaces of the support elements such that it runs, in particular with its vehicle-facing wall element, at a spacing from the vehicle rear when the support surfaces abut against the support regions.

9. The crossmember in accordance with claim 5, wherein the wall element with its extensions forms support plates having the support surfaces.

10. The crossmember in accordance with claim 9, wherein the extensions form bends which adjoin the support plates and stiffen them.

11. The crossmember in accordance with claim 9, wherein the support plates are connected to the wall element in the region of the box structure by inner bends formed by the extensions.

12. The crossmember in accordance with claim 11, wherein the support plates are connected to outer bends on their sides opposite the inner bends.

13. The crossmember in accordance with claim 10, wherein the support plates have at least one bend extending approximately parallel to the transverse direction.

14. The crossmember in accordance with claim 1, wherein one of the wall elements of the box-shaped structure forms an impact-absorbing impact element thereof, which forms impact surfaces both in the region of the central unit and in the region of the support elements and transmits impact forces to further wall elements of the box-shaped structure and to the support elements.

15. The crossmember in accordance with claim 14, wherein the impact-absorbing wall element is itself deformable.

16. The crossmember in accordance with claim 14, wherein the impact-absorbing wall element is the wall element of the box-shaped structure facing away from the vehicle.

17. The crossmember in accordance with claim 14, wherein the impact-absorbing wall element is connected to at least one wall element supporting it approximately parallel to the direction of travel.

18. The crossmember in accordance with claim 17, wherein the at least one wall element supporting approximately parallel to the direction of travel is connected to the vehicle-facing wall element.

19. The crossmember in accordance with claim 17, wherein the box-shaped structure has two wall elements which act in a supporting manner approximately parallel to the direction of travel and are arranged at a spacing from one another.

20. The crossmember in accordance with claim 17, wherein at least one wall element acting in a supporting manner in the direction of travel is a roadway-facing wall element of the crossmember.

21. The crossmember in accordance with claim 17, wherein the at least one wall element acting in a supporting manner in the direction of travel is a wall element of the crossmember facing away from the roadway.

22. The crossmember in accordance with claim 1, wherein the at least one wall element acting in a supporting manner in the direction of travel is supported both in the region of the central unit and in the region of the support elements.

23. The crossmember in accordance with claim 17, wherein the at least one wall element acting in a supporting manner approximately parallel to the direction of travel is deformable for absorbing impact energy.

24. The crossmember in accordance with claim 1, wherein the at least one wall element acting in a supporting manner approximately parallel to the direction of travel is supported in the region of the support elements by its one-piece extensions on the support plates.

25. The crossmember in accordance with claim 24, wherein the at least one wall element acting in a supporting manner approximately parallel to the direction of travel is supported in a planar manner by its one-piece extensions on the support plates by way of support flanges.

26. The crossmember in accordance with claim 25, wherein the support flanges together with the support plates are connectable to the support regions of the vehicle rear by way of mounting elements acting on both.

27. The crossmember in accordance with claim 19, wherein the one-piece extensions of the at least one wall element acting in a supporting manner approximately parallel to the direction of travel form a hollow body stiffening said wall element.

28. The crossmember in accordance with claim 27, wherein in each case a hollow body is formed as a support body and is supported on one of the support plates.

29. The crossmember in accordance with claim 28, wherein each hollow body extends in the direction of the corresponding support plate with an increasingly widening cross-section.

30. The crossmember in accordance with claim 28, wherein the hollow body is formed as a semi-pyramid.

31. The crossmember in accordance with claim 24, wherein the hollow body is formed by bending of the corresponding extension at least three times.

32. The crossmember in accordance with claim 27, wherein each hollow body is supported by flange elements on the corresponding support plate.

33. The crossmember in accordance with claim 32, wherein the flange elements together with the corresponding support plate are connectable to the support regions of the vehicle rear by way of mounting elements acting on both.

34. The crossmember in accordance with claim 1, wherein the box-shaped structure has at least one wall element which is provided with at least one cut-out.

35. The crossmember in accordance with claim 34, wherein the at least one cut-out has an areal extent which corresponds in each direction to a maximum of 2 times the areal extent of a surface region surrounding it in the corresponding direction.

36. The crossmember in accordance with claim 34, wherein the at least one cut-out is surrounded on all sides by the surface region.

37. The crossmember in accordance with claim 34, wherein the at least one cut-out has an outer contour with at least one of i) a substantially round basic shape and ii) a substantially oval basic shape.

38. The crossmember in accordance with claim 34, wherein the at least one cut-out, with respect to the surface region surrounding it, has an edge region which is raised relative to this surface region.

39. The crossmember in accordance with claim 38, wherein the raised edge region has a height transverse to the surface region surrounding it which corresponds to at least twice a material thickness of the surface region surrounding it.

40. The crossmember in accordance with claim 1, wherein at least some of the wall elements of the box-shaped structure, as a result of re-shaping, have an increased rigidity against deformation.

41. The crossmember in accordance with claim 40, wherein at least one of the wall elements of the box-shaped structure has a bending line running approximately parallel to the vertical longitudinal center plane.

42. The crossmember in accordance with claim 40, wherein at least one of the wall elements has at least one embossed bead.

43. The crossmember in accordance with claim 42, wherein at least one of the walls has at least one embossed bead which extends in a transverse direction with respect to the vertical longitudinal center plane.

44. The crossmember in accordance with claim 1, wherein the central unit is formed in such a way that a hitch element for a trailer or a load carrier is mountable on it, and wherein the forces transmitted by the hitch element to the central unit are transmitted from the central unit to the support elements and from these to the support regions of the vehicle rear.

45. The crossmember in accordance with claim 44, wherein the box-shaped structure of the central unit carries a receiving unit for the hitch element.

46. The crossmember in accordance with claim 45, wherein the receiving unit for the hitch element is arranged in the central unit.

47. The crossmember in accordance with claim 44, wherein the receiving unit for the hitch element is arranged in an interior of the central unit.

48. The crossmember in accordance with claim 47, wherein a roadway-facing wall of the central unit has an opening through which the hitch element with the mounting unit is insertable into the interior.

49. The crossmember in accordance with claim 44, wherein the hitch element in its working position reaches through the opening.

50. The crossmember in accordance with claim 44, wherein the hitch element in a rest position is arranged substantially in the interior of the box-shaped structure of the central unit.
